(19) United States
(12) Patent Application Publication
(10) Pub. No.: US 2026/0184246 A1
(43) Pub. Date: Jul. 2, 2026

(54) SEATBACK

(71) Applicants: TS TECH CO., LTD., Asaka-shi (JP); HONDA MOTOR CO., LTD., Tokyo (JP)

(72) Inventors: Hidetsune NONAKA, Shioya-gun (JP); Yoshiaki ITO, Shioya-gun (JP); Ikumaru NOZAWA, Shioya-gun (JP); Tadashi SO, Shioya-gun (JP); Tsuyoshi KOMORI, Shioya-gun (JP); Manabu MATSUMOTO, Wako-shi (JP)

(21) Appl. No.: 19/428,505

(22) Filed: Dec. 22, 2025

(30) Foreign Application Priority Data
Dec. 26, 2024 (JP) 2024-231154

(51) Int. Cl. B60N 2/68; B60N 2/64; B60N 2/803

(52) U.S. Cl. CPC B60N 2/68; B60N 2/64; B60N 2/803

(57) ABSTRACT

A seatback includes: a seatback frame that is a framework of the seatback; a headrest that supports a head of a seat occupant; and a headrest pillar that is coupled to an upper portion of the seatback frame and supports the headrest. The headrest pillar includes: a fixed portion that is fixed to an upper end front surface of the seatback frame; and a first bend that begins to extend rearward from the fixed portion.

### CROSS-REFERENCE TO RELATED APPLICATIONS

The entire disclosure of Japanese Patent Application No. 2024-231154 filed on Dec. 26, 2024 is incorporated herein by reference in its entirety.

### BACKGROUND OF THE INVENTION

### Technical Field

The present disclosure relates to a seatback having a headrest supported by a headrest pillar.

### Description of Related Art

The upper portion of the seatback of a vehicle seat is equipped with a headrest that protects the head and neck of the seat occupant from the impact of a rear collision. The headrest is generally fixed to the upper portion of the seatback frame that serves as the framework of the seatback.

In the past, a technique for fixing the headrest to the seatback frame was to position a bracket adhered to the headrest frame, which is the core material of the headrest, on the front side of the seatback frame, sandwich the upper horizontal portion of the seatback frame between the bracket and a plate located on the rear side of the seatback frame, and then tighten bolts (e.g., JP No. H04-109913 A).

There is also a technique in which a pillar guide mounting frame is provided parallel to the upper frame of the seatback frame, a pair of tubular pillar guides are adhered across the upper frame and the pillar guide mounting frame, and a pillar, which is the core material of the headrest, is inserted into the pillar guides, thereby attaching the headrest to the upper portion of the seatback frame (e.g., JP No. 2016-210319 A).

### SUMMARY OF THE INVENTION

In the invention of the headrest in JP No. H04-109913 A and the passenger seat in JP No. 2016-210319 A, the headrest is positioned on the front side of the seatback frame, so the thickness of the headrest cushion is not be sufficiently secured. Therefore, it is required to have more sufficient strength against impact loads due to collision.

On the other hand, to allow for a larger headrest cushion thickness, the lower end of the pillar supporting the headrest could be welded or otherwise fixed to the rear surface of the upper portion of the seatback frame. However, when the lower end of the pillar is fixed to the upper portion rear side of the seatback frame in this manner, the moment caused by the force applied to the headrest from the head of the seat occupant during a crash acts to strip the welds of the pillar. Therefore, further improvement of the joint rigidity of the headrest pillar to the seatback frame is required.

The present disclosure was made in view of the above-mentioned problem, and is intended to provide a seatback that can sufficiently secure the thickness of the cushion of the headrest to enhance the function of protecting the head and neck of the seat occupant.

Another objective of the present disclosure is to provide a seatback that can increase the rigidity of the attachment of the headrest pillar to the seatback frame.

To achieve at least one of the abovementioned objects, according to an aspect of the present invention, a seatback reflecting one aspect of the present invention includes:
a seatback frame that is a framework of the seatback;
a headrest that supports a head of a seat occupant; and
a headrest pillar that is coupled to an upper portion of the seatback frame and supports the headrest, wherein
the headrest pillar includes:
   a fixed portion that is fixed to an upper end front surface of the seatback frame; and
a first bend that begins to extend rearward from the fixed portion.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagrammatic view showing an example of the configuration of members that serve as the framework inside the headrest installed in the upper portion of the seatback in accordance with the present disclosure;

FIG. 2 is a front view showing an example of the configuration of the upper portion of the seatback frame constituting the seatback of the present disclosure;

FIG. 3 is a side view of the configuration of the framework members inside the headrest shown in FIG. 1 seen from the side;

FIG. 4 is an exploded diagrammatic view of the headrest constituting the seatback of the embodiment;

FIG. 5 is a diagrammatic view of the coupled headrest pillar and the bracket constituting the headrest; and

FIG. 6 is a cross-sectional side view of the interior configuration of the headrest in the embodiment.

### DETAILED DESCRIPTION

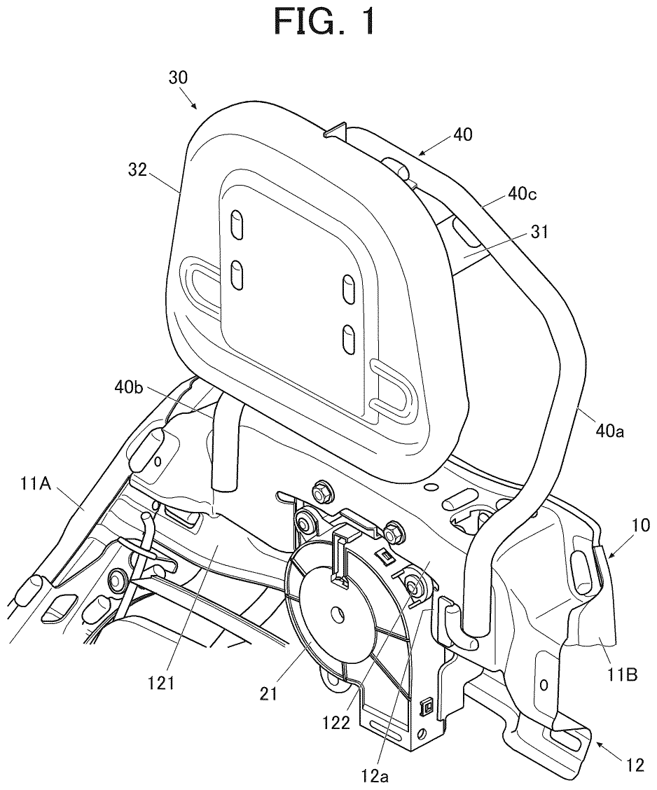

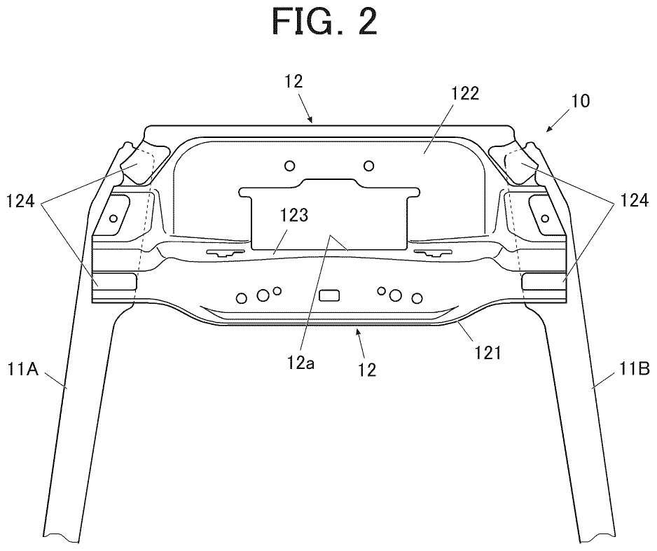

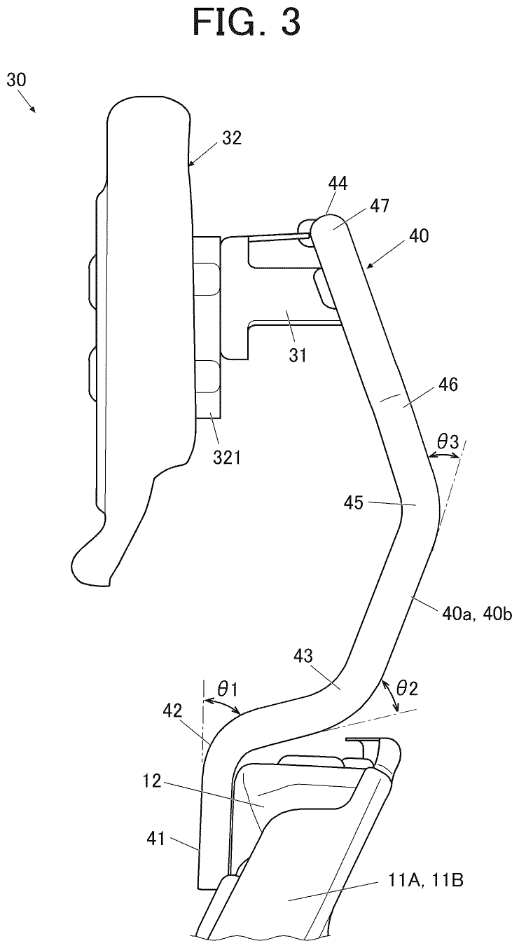

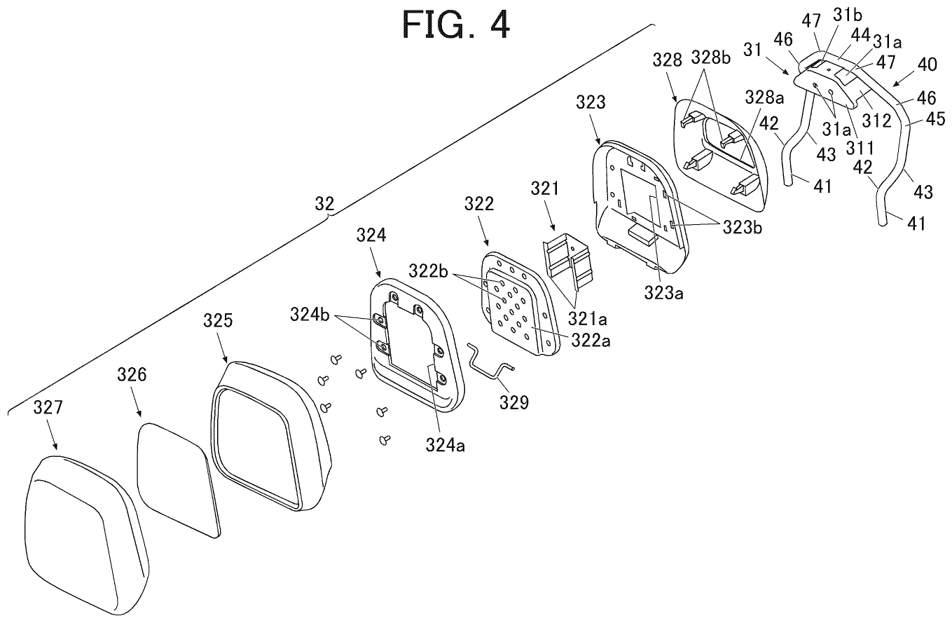

The following is a description of an embodiment of a seatback and a vehicle seat of the present disclosure with reference to the drawings. FIG. 1 is a diagrammatic view showing an example of the configuration and installation structure of the member that serves as the framework inside the headrest installed in the upper portion of the seatback. FIG. 2 shows a front view of an example configuration of the upper portion of the seatback frame constituting the seatback shown in FIG. 1. FIG. 3 shows a side view of the configuration of the member that serves as the framework inside the headrest shown in FIG. 1. FIG. 4 is an exploded diagrammatic view of the headrest. In the following description, unless otherwise mentioned, the direction of vehicle travel is referred to as forward and the opposite direction is referred to as rearward.

As shown in FIG. 1, the body 32 of the headrest provided at the upper portion of the seatback of this embodiment is coupled to the front surface side of the upper portion of the headrest pillar 40, which has an inverted U shape in front view, with its lower ends welded or otherwise adhered to the front surface of the upper portion of the seatback frame 10, which is the framework of the seatback. The body 32 is configured to be supported by the seatback frame 10 via the headrest pillar 40.

Specifically, the headrest has a base frame 31 protruding rearward from the back and the headrest body 32 attached to the base frame 31, with the rear end of the base frame 31 adhered to the upper portion of the headrest pillar 40 by welding. The headrest body 32 has members that serve as shock-absorbing pads and covers, as described in more detail below.

The headrest pillar 40 is bent to expand rearward, and the lower ends of the legs 40a, 40b are adhered, by welding, to the front surface of the protruding surface 122 of the upper frame 12 constituting the seatback frame 10. By providing the upper frame 12 with the protruding surface 122 and adhering the lower ends of the legs 40a, 40b of the headrest pillar 40, a wider welding range can be achieved and the joint rigidity of the headrest pillar 40 can be increased.

On the other hand, the seatback frame 11 has a seatback frame 10 that is formed in an inverted U shape viewed from the seat front-rear direction, having a pair of left and right side frames 11A, 11B and an upper frame 12 provided in the width direction that straddles between the upper ends of the side frames 11A, 11B. The upper frame 12 and side frames 11A, 11B are welded together to form a rigid joint.

Although not shown in the figure, a lower frame horizontally spans and is rigidly joined between the lower ends of the above side frames 11A and 11B. On the front surface side of the seatback frame 10, a cushion pad made of foam rubber or urethane foam and a pan frame that supports the cushion pad are placed, and the surface of the cushion pad is covered with a surface skin.

When a seatback equipped with the headrest according to this embodiment is used in a vehicle seat, the lower end of the seatback frame 10 is connected to the rear end of the seat cushion frame, which serves as the framework of the seat cushion, in a tiltable manner via a hinge.

The side frames 11A, 11B, which form the framework of the seatback, may consist of an inner side frame and an outer side frame, or may be made of pipes or a pan frame.

The above upper frame 12 has a lower base 121 and a protruding surface 122 protruding forward from the base 121, which has an opening 12a for inserting a blower 21. As shown in FIG. 2, between the base 121 and the protruding surface 122, there is a horizontal piece 123, which also has an opening, so that the opening 12a forms an L-shape in lateral view from the base 121 to the protruding surface 122. As described above, the protruding surface 122 has a shape protruding forward from the base 121, and the opening 12a is formed from the base 121 to the protruding surface 122 to form a storage recess that can store the blower 21. In FIG. 2, the reference numeral 124 indicates joint adhering portions between the two sides of the above upper frame 12 and the upper ends of the side frames 11A, 11B.

Next, the detailed configuration and support structure of the headrest 30 in this embodiment will be described. FIG. 3 shows a side view of the support structure, including the configuration of the framework members inside the headrest 30 shown in FIG. 1 (excluding the members that serve as cushions) and the headrest pillar 40 that supports it.

As mentioned above, in this embodiment, the headrest pillar 40 is bent to expand rearward, and the lower ends of the legs 40a, 40b are adhered, by welding, to the front surface of the protruding surface 122 of the upper frame 12.

Thus, the lower ends of the legs 40a, 40b serve as a fixed portion 41 for fixing the headrest pillar 40 to the upper front surface of the seatback frame 10. By fixing the fixed portion 41 to the upper front surface of the seatback frame 10, even if an impact from the head of a seat occupant acts on the headrest pillar 40 during vehicle collision from the rear side, the force will not work to peel off the welding portion of the fixed portion 41, and thus the headrest pillar 40 can be fixed to the seatback frame 10 more rigidly than when the fixed portion 41 is fixed to the upper portion rear surface of the seatback frame 10.

Furthermore, the headrest pillar 40 of this embodiment has a pair of left and right legs 40a, 40b, each of which has a first bend 42 that starts extending rearward from the upper portion of the above fixed portion 41, a second bend 43 that starts extending upward in relation to a straight line connecting the above fixed portion 41 and the above first bend 42 above the rear end of the upper frame 12, and a third bend 45 that starts extending forward relative to the straight line connecting the first bend 42 and the second bend 43 between an upper horizontal portion 44 of the headrest pillar 40 and the second bend 43.

The headrest pillar 40 can be formed by bending steel bars or steel pipes by a bending process. The headrest frame 31 is coupled to the upper horizontal portion 44 of the headrest pillar 40. It is preferable that the bending angle θ1 at the first bend 42 is smaller than 90 degrees.

By bending the headrest pillar 40 at the three bends as described above, the headrest 30 is attached to the headrest pillar 40 behind the front surface of the upper portion of the seatback frame 10.

This allows the cushion of the headrest body 32 to be thick enough to sufficiently enhance the function of protecting the head and neck of the seat occupant from impact in the event of a collision. The headrest pillar 40 has a shape in which the center portion expands rearward in the lateral view and the part above the third bend 45 tilts forward, which increases the resistance of the headrest pillar 40 to forces acting from the front and makes it less prone to plastic deformation.

In addition, by providing a plurality of bends in the headrest pillar 40, the headrest pillar can be bent in a more reproducible manner than when the entire pillar is formed in a curved shape.

Here, the condition for the part above the third bend 45 to have a forward-tilted shape is θ1<(θ2+θ3), where the rearward bending angle at the first bend 42 is θ1, the upward bending angle at the second bend 43 is θ2, and the forward bending angle at the third bend 45 is θ3. If the bending angle at each bend is set so that θ1=(θ2+θ3), the part above the third bend 45 is parallel to the fixed portion 41 in the side view.

When a rearward force acts on the upper end of the headrest pillar 40 from the headrest 30, the bending moment generated at the second bend 43 is greater than the bending moment generated at the third bend 45. Therefore, it is conceivable to set the bending angles at the second and third bends so that θ2>θ3.

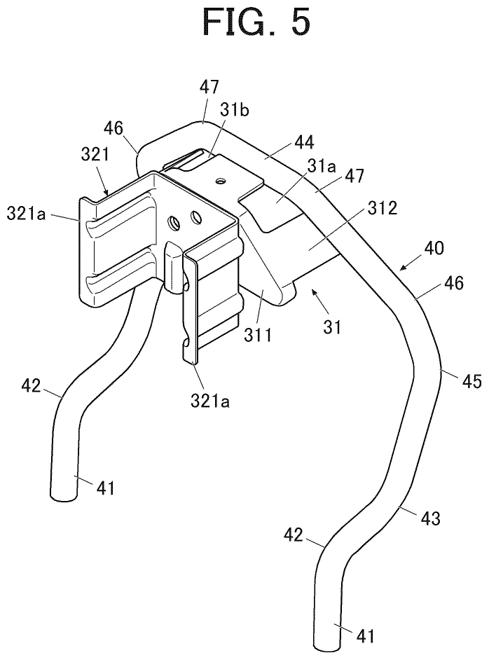

Furthermore, the headrest pillar 40 of this embodiment is formed such that a spanning portion 40c (see FIG. 1) has a pair of fourth bends 46 (see FIG. 5) that begin extending upwardly sloping toward the center of the seatback at a slightly higher position than the third bend 45, and a pair of fifth bends 47 that are bent to change orientation thereof in a horizontal direction at the part sandwiched between the pair of fourth bends 46. In this specification, the part between the left and right pair of fourth bends 46 in the headrest pillar 40 is referred to as a spanning portion, and the part between the fourth bend 46 and the fixed portion 41 is referred to as the leg portion.

The headrest frame 31, which is coupled to the upper horizontal portion 44 of the headrest pillar 40, has a trapezoidal plate 311 arranged along an approximately vertical direction, as shown in FIG. 5, and a roof-shaped extension 312 that extends rearward from the upper and left/right diagonal edges of the plate 311a, and whose rear ends are adhered, by welding, to the headrest pillar 40. Thus, the extension 312 makes it easier to couple the headrest frame 31 as a support of the headrest body 32 to the headrest pillar 40.

Here, the plate 311 above has a pair of bolt insertion holes 31a through which bolts are inserted to fix the bracket 32A described below, and the extension 312 has two openings 31b to reduce weight.

The headrest frame 31 is then adhered by welding to the periphery of the upper horizontal portion 44 of the headrest pillar 40 at the tips (rear ends) of the three wall portions flanking the two openings 31b of the extension 312.

As described above, the headrest frame 31 is adhered to the upper portion of the headrest pillar 40 by welding at three points, which reduces the extent of welding while maintaining the necessary joint rigidity, thereby improving workability. If three welding points are simply welded without the two openings 31b, it is easy for variations in welding points to occur between products, but by limiting the welding points with the two openings 31b, product variations can be reduced.

The headrest frame 31 as a support of the headrest body 32 is attached to the headrest pillar 40 so that the support plate 311 is positioned forward of the upper end of the headrest pillar 40 in the seat front-rear direction, so that the headrest frame 31 can efficiently transmit and absorb the force from the seat occupant's head acting on the headrest.

On the other hand, as shown in FIG. 4, the headrest body 32 has a U-shaped bracket 321 for mounting the headrest, which is fixed to the front surface of the plate 311 of the headrest frame 31 by means of bolts and nuts, and a pressure receiver 322, which is arranged to contact the front surface of the bracket 321 and is made of a rigid material to receive impact loads from the head of a seat occupant during a rear-end collision and transmit them directly to the headrest frame 31 via the bracket 321. The bracket 321 has a flange 321a formed at the front end of each of the left and right side walls. The pressure receiver 322 has a stepped portion 322a on the front surface, where the center portion is one step higher than the edge portion, and a plurality of small holes 322b are formed in this stepped portion.

The headrest body 32 has a rear inner case 323 made of synthetic resin having an opening 323a large enough to fit the body of the bracket 321 and a front inner case 324 also made of synthetic resin having an opening 324a large enough to fit the front surface stepped portion 322a of the pressure receiver 322 above.

These rear inner case 323 and front inner case 324 are formed to be one size larger than the pressure receiver 322 in the front view, and a plurality of screw insertion holes 323b, 324b are formed along the periphery, and by inserting bolts through these screw insertion holes 323b, 324b respectively and screwing nuts, the parts can be coupled.

Therefore, when fixing the bracket 321 to the headrest frame 31, it is fixed in the state of being fitted into the opening 323a of the rear inner case 323, and the front surface stepped portion of the pressure receiver 322 is fitted into the opening 324a of the front inner case 324. In that state, it is joined to the front surface of the rear inner case 323, and thereafter the front inner case 324 and the rear inner case 323 are unified with bolts and nuts. Then, the edge of the opening 323a of the rear inner case 323 contacts the rear surfaces of the left and right flanges 321a of the bracket 321, and the front surface of the flanges 321a contacts the rear surface of the pressure receiver 322.

This allows the front inner case 324 and rear inner case 323 to sandwich the pressure receiver 322 from front and rear sides, and these can be fixed to the headrest frame 31 via bracket 321, as shown in FIG. 3. The rear inner case 323 and front inner case 324 serve as protective members covering the outer edge of the pressure receiver 322.

Furthermore, in the headrest body 32 of this embodiment, a pad 325 having shock absorbing properties such as foam rubber or urethane foam is placed on the front surface side of the front inner case 324 above. Furthermore, a slab (urethane slab) 326, which is made of a softer material than pad 325 and improves the feel of the headrest when a seat occupant places his/her head on it, is placed on the front surface side of the pad 325, and the front surface side of slab 326 is covered by front cover 327 made of an elastic material. The pad 325 is formed to be one size larger than the front inner case 324 in the front view. A shallow recess is formed in the front surface of pad 325 for placing the slab 326, which prevents the slab 326 from moving (shifting).

As described above, by forming a plurality of small holes 322b in the stepped portion of the pressure receiver 322, when the head of a seat occupant hits the headrest during a rear collision and the slab 326 and pad 325 are compressed and deformed, air inside can escape to the rear through the small holes 322b in the pressure receiver 322, thereby reducing the impact to the head.

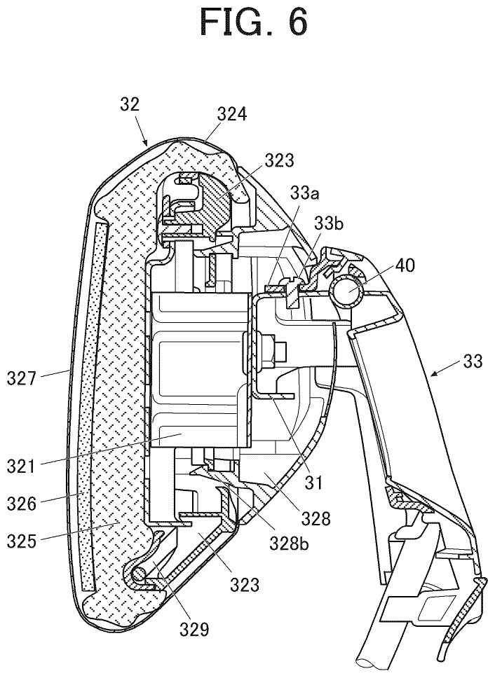

In the headrest body 32, a rear cover 328, which is concave toward the rear and has a bowl shape, is placed at the rear side of the above rear inner case 323. The rear cover 328 has an opening 328a shaped to correspond to the headrest frame 31, and the four inner corners of the bowl are each provided with a fastening piece 328b protruding forward and having a claw at the tip. Although not shown in FIG. 4, an fastening hole is formed in a part of the rear inner case 323 corresponding to the above-mentioned fastening piece 328b, and the claw at the tip of the fastening piece 328b is engaged with the fastening hole in the rear inner case 323, thereby fastening the rear cover 328 to the rear side of the rear inner case 323 (see FIG. 6).

FIG. 6 is a cross-sectional side view of the above components constituting the headrest body 32 of this embodiment assembled to the headrest frame 31.

As shown in FIG. 6, in the headrest body 32 of this embodiment, the pad 325 is attached to the front surface side of the front inner case 324, covering the front surface and edges of the front inner case 324, and the front cover 327 is also attached to cover the front surface and edges of that pad 325. Between the lower ends of the rear inner case 323 and the front inner case 324, there is a pressure wire 329 made of an elastic material such as spring material.

As shown in FIG. 4, the above pressure wire 329 is bent so that its center forms a semi-rectangular shape, and the shafts at both ends are inserted into engagement portions in the front inner case 324, which are not shown. As shown in FIG. 6, the central hook-shaped portion of the pressure wire 329 is arranged to slope downward toward the front, and the tip engages the bottom edge of the front inner case 324 from behind. As a result, the bottom edge of the front inner case 324 is pressed forward and compressed and deformed so that the thickness of the part slightly inward from the bottom edge of the pad 325 covering the front side is smaller than the edge, thereby making the edge of the pad 325 less likely to come off the front inner case 324.

Furthermore, in the headrest of this embodiment, as shown in FIG. 6, a cosmetic cover 33 is configured to cover the rear of the headrest frame 31 and the spanning portion 40c at the upper portion of the headrest pillar 40, which is located at the rear of the rear inner case 328 above.

Specifically, the upper portion of the cosmetic cover 33 has an L-shaped mounting bracket 33a protruding forward, and this bracket 33a is fixed to the upper surface of the headrest frame 31 with screws 33b, thereby attaching the cosmetic cover 33 to the upper portion of the headrest pillar 40.

As described above, the cosmetic cover 33 improves the appearance of the seatback by preventing the headrest frame 31 and bracket 321 from being directly visible from the rear.

One embodiment of the present disclosure is described above. The present disclosure is not limited to the above embodiment, but may be implemented with various changes to the extent not departing from the gist thereof. For example, in the above embodiment, the bracket 321 for fixing the headrest body 32 to the headrest frame 31 is arranged to form a U shape in the top view, but the bracket 321 may be arranged to form a U shape in the side view. The bracket 321 may be formed in a box shape with an opening on one side instead of a U-shape, and flanges may be provided on each of the four edges of the opening.

In the embodiment, the headrest pillar 40 is formed with two legs 40a, 40b and a spanning portion 40c between the upper portions of the legs 40a, 40b, but it may consist of only one pillar arranged in the up-down direction. However, as in the embodiment, the configuration with two legs 40a, 40b can increase the strength in the torsional direction compared to the case with one leg. Although it was explained that the base frame 31 is adhered to the headrest pillar 40 by welding or other means, by providing a flange on the headrest pillar 40, it may be coupled to that flange by bolts and nuts. And in this case, the bracket 321 can be omitted.

In the above embodiment, the fixed portion 41 of the headrest pillar 40 is described as being fixed to the front surface of the upper frame 12 by welding, but instead of welding, it may be fixed using an omega-shaped fastening bracket (saddle band) and bolts and nuts. It is also possible to configure the height of the headrest to be adjustable, for example, by making the fixed portion 41 of the headrest pillar 40 a double pipe structure.

Furthermore, in the above embodiment, the seatback of the present disclosure is described as applied to a vehicle seat as an example. However, the present disclosure is not limited to vehicle seats, but can also be applied to seats for ships, aircraft, and other vehicles, as well as seats (sofas) as furniture.

According to the above-described embodiments of the present invention, there is provided a seatback including: a seatback frame that is a framework of the seatback; a headrest that supports a head of a seat occupant; and a headrest pillar that is coupled to an upper portion of the seatback frame and supports the headrest. The headrest pillar includes: a fixed portion that is fixed to an upper end front surface of the seatback frame; and a first bend that begins to extend rearward from the fixed portion.

With this configuration, the cushion of the headrest can be sufficiently thick to enhance the function of protecting the head and neck of the seat occupant. It can also increase the rigidity of the headrest pillar attachment to the seatback frame.

It is preferred that the seatback frame includes: a pair of side frames spaced apart in a left-right direction; and an upper frame that horizontally spans between upper ends of the pair of side frames and has both ends coupled to the side frames, and the headrest pillar has a lower end adhered to a front surface of the upper frame, and includes a second bend that begins to extend upwardly relative to a first extension extending from the first bend above vicinity of an adhered portion with the upper frame.

With this configuration, headrest pillar of the desired shape can be formed with good reproducibility.

It is preferred that the second bend is arranged forward of a rear end of the upper frame in a seat front-rear direction.

With this configuration, it is possible to reduce the rearward projection of the headrest pillar and contribute to the compactness of the headrest in the front-rear direction.

It is preferred that the headrest pillar includes a third bend between an upper end of the headrest pillar and the second bend, the third bend beginning to extend forward relative to a second extension extending from the second bend.

With this configuration, the upper portion of the headrest pillar can be tilted forward to increase resistance to forces acting from the front and to reduce plastic deformation.

It is preferred that the third bend is arranged rearward in the seat front-rear direction from the rear end of the upper frame.

With this configuration, it is possible to increase the bending angle at the third bend of the headrest pillar.

It is preferred that the seatback further includes a support that supports the headrest, and the headrest is attached to the upper end of the headrest pillar via the support at a rearward position in the seat front-rear direction from the first bend.

This configuration improves the rigidity of the coupling between the body of the headrest and the upper portion of the headrest pillar. In addition to ensuring sufficient thickness of the headrest cushion, the flexure of the headrest pillar itself can also be used to enhance the function of protecting the head and neck of the seat occupant.

It is preferred that the support includes a plate to which the headrest is coupled, and an extension extending rearward from the plate, the extension is fixed to the headrest pillar by being adhered to the upper end of the headrest pillar, and the extension is adhered to the upper end of the headrest pillar at at least three or more locations.

With this configuration, it is possible to make it easier to couple the support (headrest frame) to the headrest pillar.

It is preferred that the headrest pillar includes a pair of fourth bends that begin to extend upwardly sloping toward a center of the seatback at a position slightly higher than the third bend.

This configuration makes it possible to form the headrest pillar of the desired shape with good reproducibility.

It is preferred that the seatback further includes a pair of fifth bends bent to change an orientation in a horizontal direction at a part sandwiched between the pair of fourth bends, and the extension is adhered to the upper end of the headrest pillar at a position avoiding the fifth bends.

With this configuration, the support of the headrest can be adhered (welded) to the upper end of the headrest pillar with relative ease.

It is preferred that a lower end of the headrest is located below the third bend.

With this configuration, a headrest body with the desired length in the up-down direction can be placed at an appropriate height position.

Although embodiments of the present invention have been described and illustrated in detail, the disclosed embodiments are made for purposes of illustration and example only and not limitation. The scope of the present invention should be interpreted by terms of the appended claims.

1. A seatback comprising:
a seatback frame that is a framework of the seatback;
a headrest that supports a head of a seat occupant; and
a headrest pillar that is coupled to an upper portion of the seatback frame and supports the headrest, wherein
the headrest pillar includes:
a fixed portion that is fixed to an upper end front surface of the seatback frame; and
a first bend that begins to extend rearward from the fixed portion.

2. The seatback according to claim 1, wherein
the seatback frame includes:
a pair of side frames spaced apart in a left-right direction; and
an upper frame that horizontally spans between upper ends of the pair of side frames and has both ends coupled to the side frames, and
the headrest pillar has a lower end adhered to a front surface of the upper frame, and includes a second bend that begins to extend upwardly relative to a first extension extending from the first bend above vicinity of an adhered portion with the upper frame.

3. The seatback according to claim 2, wherein the second bend is arranged forward of a rear end of the upper frame in a seat front-rear direction.

4. The seatback according to claim 3, wherein the headrest pillar includes a third bend between an upper end of the headrest pillar and the second bend, the third bend beginning to extend forward relative to a second extension extending from the second bend.

5. The seatback according to claim 4, wherein the third bend is arranged rearward in the seat front-rear direction from the rear end of the upper frame.

6. The seatback according to claim 4, further comprising a support that supports the headrest, wherein
the headrest is attached to the upper end of the headrest pillar via the support at a rearward position in the seat front-rear direction from the first bend.

7. The seatback according to claim 6, wherein
the support includes a plate to which the headrest is coupled, and an extension extending rearward from the plate,
the extension is fixed to the headrest pillar by being adhered to the upper end of the headrest pillar, and
the extension is adhered to the upper end of the headrest pillar at at least three or more locations.

8. The seatback according to claim 7, wherein the headrest pillar includes a pair of fourth bends that begin to extend upwardly sloping toward a center of the seatback at a position slightly higher than the third bend.

9. The seatback according to claim 8, further comprising a pair of fifth bends bent to change an orientation in a horizontal direction at a part sandwiched between the pair of fourth bends, wherein
the extension is adhered to the upper end of the headrest pillar at a position avoiding the fifth bends.

10. The seatback according to claim 9, wherein a lower end of the headrest is located below the third bend.
